(19) United States
(12) Patent Application Publication
(10) Pub. No.: US 2009/0073812 A1
(43) Pub. Date: Mar. 19, 2009

(54) AUDIO/VIDEO ALARM CLOCK AND PRE-SET TIME REMINDING METHOD THEREOF

(75) Inventor: Chen-Chang HSU, Taichung City (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: WINTEK CORPORATION, Taichung (TW)

(21) Appl. No.: 12/212,824

(22) Filed: Sep. 18, 2008

Related U.S. Application Data
(60) Provisional application No. 60/960,167, filed on Sep. 19, 2007.

(30) Foreign Application Priority Data
Nov. 28, 2007 (TW) 96145134

(51) Int. Cl. G04C 21/00; G04B 47/00

(52) U.S. Cl. 368/10; 368/73

(57) ABSTRACT

An audio/video alarm clock and a pre-set time reminding method thereof. The audio/video alarm clock includes a time function unit, an audio play unit and a video play unit, which includes a touch screen. The time function unit provides a current time. The video play unit displays the current time when the current time is not a pre-set time. The audio play unit and the video play unit respectively play prerecorded audio data and prerecorded video data when the current time is the pre-set time. At this time, the audio play unit stops playing the prerecorded audio data if the touch screen is touched.

This application claims the benefits of U.S. provisional application Ser. No. 60/960,167, filed Sep. 19, 2007 and Taiwan application Serial No. 96145134, filed Nov. 28, 2007, the subject matter of which is incorporated herein by reference.

### BACKGROUND OF THE INVENTION

1. Field of the Invention

The invention relates in general to an alarm clock, and more particularly to an audio/video alarm clock and a pre-set time reminding method thereof.

2. Description of the Related Art

In the busy life, the human beings tend to forget some events when they have paid too much attention to other events. For example, the user may pay too much attention to the television program, and forgets the food being cooked or forgets the time of taking the trash out so that the preparation is caramelized and the trash turns putrid to bring some troubles in the user's life.

However, a certain user may remind himself or herself to finish a specific job at a specific time using a memo or a timer in order to get rid of the above-mentioned troubles. However, the memo is often placed freely or even tends to be lost so that the good reminding effect cannot be effectively achieved. The timer only can tell the user that the pre-set time is reached, but cannot remind the user of what should be done at the pre-set time.

### SUMMARY OF THE INVENTION

The invention is directed to an audio/video alarm clock and a pre-set time reminding method thereof. When a current time is not a pre-set time, the audio/video alarm clock displays the current time. When the pre-set time is reached, the audio/video alarm clock synchronously plays prerecorded audio data and prerecorded video data to remind the user. Furthermore, different prerecorded audio data and different prerecorded video data may be set in the audio/video alarm clock according to different to-be-reminded events. Therefore, when the user sees the prerecorded video image or hears the prerecorded audio sound, he or she can immediately know what the to-be-handled event is and does not have to recall the to-be-handled event carefully. Consequently, the audio/video alarm clock of the invention greatly enhances the convenience of usage for the user. For example, a user, a son's father, selects the pre-set time at 6:00 pm and records the video image and audio sound at 8:30 am on the same date. Therefore, when 6:00 pm is reached, the alarm clock plays the message including the prerecorded video image and audio sound to remind the father of picking up his son in elementary school. The video image may show the son's face or the father's car, and the audio sound may say “It time to pick up my son”. The video image can be dynamic image (e.g. moving image from digital video or image of cartoon) or at least one static image (e.g. picture from digital camera).

According to a first embodiment of the present invention, an audio/video alarm clock is provided. The audio/video alarm clock includes a time function unit, an audio play unit and a video play unit, which includes a touch screen. The time function unit provides a current time. When the current time is a pre-set time, the video play unit displays the current time. When the current time is the pre-set time, the audio play unit and the video play unit respectively play prerecorded audio data and prerecorded video data. At this time, if the touch screen is touched, the audio play unit stops playing the prerecorded audio data.

According to a second embodiment of the present invention, a pre-set time reminding method of an audio/video alarm clock is provided. The audio/video alarm clock includes a touch screen and the pre-set time reminding method includes the following steps. First, a current time is provided. Next, it is judged whether the current time is a pre-set time or not. When the current time is not the pre-set time, the current time is displayed. Oppositely, when the current time is the pre-set time, prerecorded video data and prerecorded audio data are synchronously played. When the touch screen is touched, the playing of the prerecorded audio data is stopped.

The invention will become apparent from the following detailed description of the preferred but non-limiting embodiment. The following description is made with reference to the accompanying drawings.

### BRIEF DESCRIPTION OF THE DRAWINGS

FIG. 1 is a schematic illustration showing an audio/video alarm clock according to an embodiment of the invention.

FIG. 2 is a detailed block diagram showing an audio/video alarm clock according to another embodiment of the invention.

FIG. 3 is a flow chart showing a pre-set time reminding method of an audio/video alarm clock according to the embodiments of the invention.

### DETAILED DESCRIPTION OF THE INVENTION

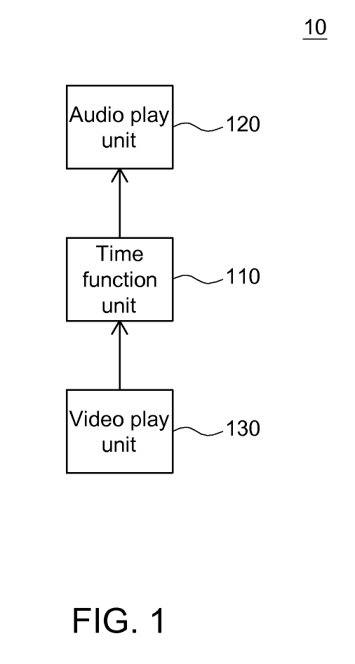

FIG. 1 is a schematic illustration showing an audio/video alarm clock 10 according to an embodiment of the invention. Referring to FIG. 1, the audio/video alarm clock 10 includes a time function unit 110, an audio play unit 120 and a video play unit 130. The video play unit 130 is, for example, a liquid crystal display, an electrowetting display, an organic light emitting diode (OLED) display, an electrophoretic display, or various electronic sheets. The liquid crystal display or the electrowetting display may enter a transmissive mode or a reflective mode in an operation state. When the display mode of the video play unit 130 is the reflective mode, an external light source may serve as a light source for the video play unit 130 in order to reduce the power consumption significantly and to lengthen the run-down time of the battery. Taking the liquid crystal display as an example, when the video play unit (liquid crystal display) 130 displays a current time, a backlight source of the liquid crystal display is turned off, and the display mode is in the reflective mode. When the liquid crystal display plays prerecorded video data, the backlight source of the liquid crystal display may be turned on, and the display mode is the transmissive mode.

Moreover, the audio/video alarm clock 10 can selectively installed a light sensor (not shown in FIG. 1) for detecting the intensity of external light. When the external light is strong enough, the video display mode stay in reflective mode for power saving purpose no matter the prerecorded video data are played. On the other hand, when the external light is week, the backlight source of the liquid crystal display is turned on during the playing of the prerecorded video data.

The time function unit 110 provides the current time. When the current time is not a pre-set time previously set by the user, the video play unit 130 correspondingly displays the current time so that the user obtains the current time according to the video play unit 130. Oppositely, when the pre-set time previously set by the user is reached, the video play unit 130 plays the prerecorded video data, such as a still or moving image. Meanwhile, the audio play unit 120 synchronously plays prerecorded audio data, such as a ring, music or reminding audio, to remind the user. The prerecorded video data and the prerecorded audio data may be built in the audio/video alarm clock or may be recorded by the user in advance, and the prerecorded video data and the prerecorded audio data may be played once or many times repeatedly.

Different prerecorded video data or prerecorded audio data may further be correspondingly set in the audio/video alarm clock 10 according to different to-be-reminded events. For example, the user may determine different prerecorded video data or different prerecorded audio data according to different to-be-reminded events including taking the trash out, boiling the water, answering a call, reminding to go outdoors or driving a child from or to a school. Therefore, when the user sees the prerecorded video data or hears the prerecorded audio data, he or she can immediately know what the to-be-handled event is, and does not have to recall what is the to-be-handled event. Consequently, the audio/video alarm clock 10 significantly enhances the convenience of usage for the user.

Furthermore, the video play unit 130 can include a touch screen 132. When the audio play unit 120 is playing the prerecorded audio data at the pre-set time, the user only has to gently touch the touch screen 132 so that the audio play unit 120 can stop playing the prerecorded audio data and enter a mute mode. Consequently, it is possible to avoid the trouble that the user cannot find the turn-off button when the audio/video alarm clock 10 alarms. The touch screen may be a touch panel embedded on the video play unit 130. a user can inputs instructions to the audio/video alarm clock 10 through the touch panel.

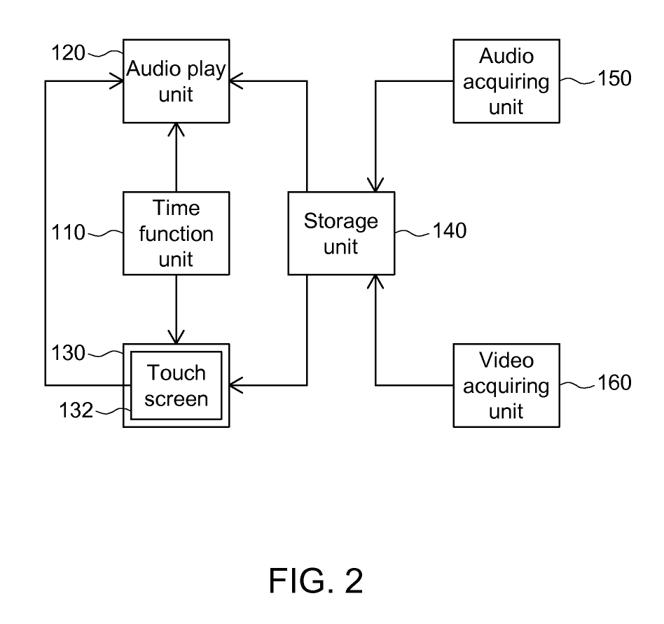

FIG. 2 is a detailed block diagram showing an audio/video alarm clock according to another embodiment of the invention. Referring to FIG. 2, the audio/video alarm clock 10 further includes a storage unit 140, an audio acquiring unit 150 and a video acquiring unit 160 in addition to the time function unit 110, the audio play unit 120 and the video play unit 130. The audio acquiring unit 150 and the video acquiring unit 160 are an audio recording element and a charge coupled device (CCD) sensor, respectively.

The storage unit 140 stores the prerecorded audio data and the prerecorded video data, and the user can record different prerecorded audio data and different prerecorded video data to the storage unit 140 in advance through the audio acquiring unit 150 and the video acquiring unit 160 according to different to-be-reminded events.

For example, the user records different reminding audio in advance by the audio acquiring unit 150 according to the different to-be-reminded events. When the pre-set time is reached, the reminding audio sounds played by the audio play unit 120 directly informs the user what the to-be-handled event is so that the user does not have to recall the to-be-handled event carefully.

In addition, the user may also record different still or moving images in advance by the video acquiring unit 160 according to the different to-be-reminded events. When the pre-set time is reached, the user sees the still or moving image, which is recorded in advance, through the video play unit 130 and thus knows what the to-be-handled event is and does not have to recall the to-be-handled event carefully. Consequently, the audio/video alarm clock 10 significantly enhances the convenience of usage for the user.

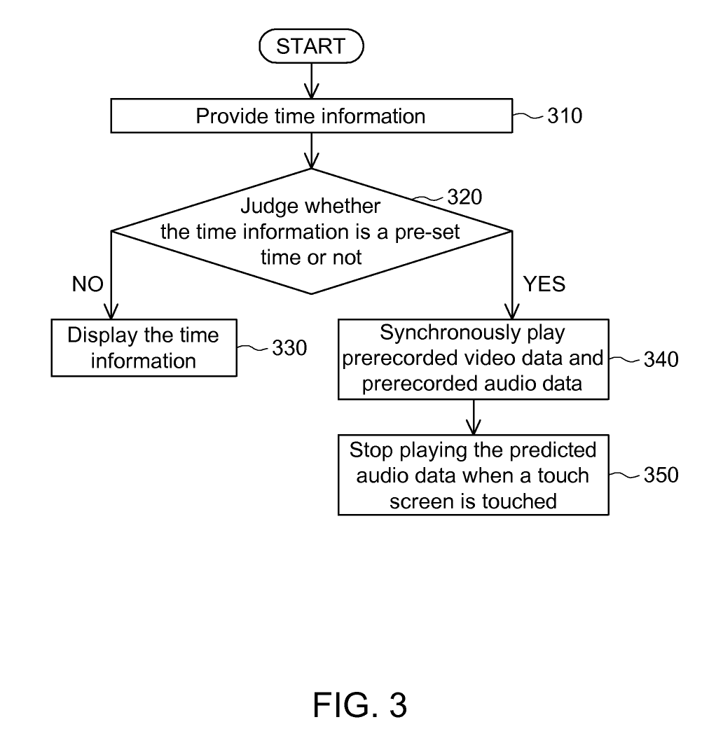

FIG. 3 is a flow chart showing a pre-set time reminding method of an audio/video alarm clock according to the preferred embodiment of the invention. The pre-set time reminding method is applied to the audio/video alarm clock 10 and includes the following steps. First, as shown in step 310, the time function unit 110 provides the current time.

Next, as shown in step 320, the audio/video alarm clock 10 judges whether the current time is the pre-set time or not. When the current time is not the pre-set time, the video play unit 130 displays the current time to let the user know the current time, as shown in step 330.

Oppositely, when the current time is the pre-set time, the video play unit 130 plays the prerecorded video data and the audio play unit 120 synchronously plays the prerecorded audio data so that the user knows what the to-be-reminded event is according to the prerecorded video data or the prerecorded audio data, as shown in step 340.

Finally, as shown in step 350, the audio play unit 120 stops playing the prerecorded audio data when the touch screen 132 is touched by the user.

The audio/video alarm clock and the pre-set time reminding method thereof according to the embodiments of the invention have the following advantages.

First, when the video play unit is in the reflective mode, the external light source may serve as the backlight source of the video play unit so that the power consumption can be greatly reduced and the run-down time of the battery can be lengthened.

Second, different prerecorded video data or different prerecorded audio data may be set in the audio/video alarm clock according to different to-be-reminded events so that the convenience of usage can be greatly enhanced.

Third, when the audio/video alarm clock alarms, it may enter the mute mode as the touch screen is gently touched. So, it is possible to avoid the trouble that the user cannot find the turn-off button when the audio/video alarm clock alarms.

While the invention has been described by way of examples and in terms of embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An audio/video alarm clock, comprising:
a time function unit for providing a current time;
an audio play unit for correspondingly playing prerecorded audio data when the pre-set time is reached; and
a video play unit for displaying the current time when the current time is not the pre-set time, and for playing prerecorded video data when the pre-set time is reached, wherein the video play unit comprises:
a touch screen, which stops playing the prerecorded audio data when the touch screen is touched.

2. The audio/video alarm clock according to claim 1, further comprising a video acquiring unit for acquiring the prerecorded video data.

3. The audio/video alarm clock according to claim 2, wherein the video acquiring unit is a charge coupled device (CCD) sensor.

4. The audio/video alarm clock according to claim 1, further comprising an audio acquiring unit for acquiring the prerecorded audio data.

5. The audio/video alarm clock according to claim 1, further comprising a storage unit for storing the prerecorded audio data and the prerecorded video data.

6. The audio/video alarm clock according to claim 1, wherein the prerecorded video data corresponds to a to-be-reminded event.

7. The audio/video alarm clock according to claim 1, wherein the prerecorded video data is a static image.

8. The audio/video alarm clock according to claim 1, wherein the prerecorded video data is a moving image.

9. The audio/video alarm clock according to claim 1, wherein the prerecorded audio data records a to-be-reminded event.

10. The audio/video alarm clock according to claim 1, wherein the video play unit is a display device, and a display mode of the display device in an operation state is at least one of a transmissive mode and a reflective mode.

11. The audio/video alarm clock according to claim 10, wherein the video play unit is a liquid crystal display device, the display mode of the liquid crystal display device is the reflective mode when the liquid crystal display device displays the current time, and the display mode of the liquid crystal display device is switched to the transmissive mode when the liquid crystal display device plays the prerecorded video data.

12. The audio/video alarm clock according to claim 10, wherein the video play unit comprises a light sensor for detecting external light.

13. A pre-set time reminding method for an audio/video alarm clock, the audio/video alarm clock comprising a touch screen, the method comprising the steps of:
(a) providing a current time;
(b) judging whether the current time is a pre-set time or not;
(c) displaying the current time when the pre-set time is not reached;
(d) synchronously playing prerecorded video data and prerecorded audio data when the pre-set time is reached; and
(e) stopping playing the prerecorded audio data when the touch screen is touched.

14. The method according to claim 13, further comprising the steps of:
(f) acquiring the prerecorded video data; and
(g) storing the prerecorded video data.

15. The method according to claim 13, further comprising the steps of:
(h) acquiring the prerecorded audio data; and
(i) storing the prerecorded audio data.

16. The method according to claim 13, wherein the prerecorded video data records a to-be-reminded event.

17. The method according to claim 13, wherein the prerecorded video data is a static image.

18. The method according to claim 13, wherein the prerecorded video data is a moving image.

19. The method according to claim 13, wherein the prerecorded audio data corresponds to a to-be-reminded event.
